(19) United States
(12) Patent Application Publication
(10) Pub. No.: US 2005/0289116 A1
(43) Pub. Date: Dec. 29, 2005

(54) File retrieving method and system

(76) Inventors: Sung-won Chae, Gwangmyeong-si (KR); Sang-kil Ahn, Suwon-si (KR)

Correspondence Address: STANZIONE & KIM, LLP, 919 18TH STREET, N.W., SUITE 440, WASHINGTON, DC, 20006, US

(21) Appl. No.: 11/107,909

(22) Filed: Apr. 18, 2005

(30) Foreign Application Priority Data
Jun. 24, 2004 (KR) 2004-47615

(51) Int. Cl. G06F 17/30

(52) U.S. Cl. 707/2

(57) ABSTRACT

A method and system to retrieve specific files stored in a plurality of output devices of the system including a host and the plurality of output devices having corresponding storage units connected to a network. The method includes transmitting a retrieval request containing inquiry conditions to one or more output devices registered in the host, accessing the corresponding storage units of the one or more output devices according to the retrieval request and transmitting the result of the retrieval request to the host, displaying the result of the retrieval request, and creating and storing a list of files stored in the corresponding storage units of the one or more output devices, and the list of the files is updated when a new file is stored in the corresponding storage units of the one or more output devices. The files stored in the output devices registered in the host can be retrieved through a single retrieval command.

### CROSS-REFERENCE TO RELATED APPLICATIONS

This application claims the priority of Korean Patent Application No. 2004-47615, filed on Jun. 24, 2004 in the Korean Intellectual Property Office, the disclosure of which is incorporated herein in its entirety by reference.

### BACKGROUND OF THE INVENTION

1. Field of the Invention

The present general inventive concept relates to a file retrieving method and system, and more particularly, to a file retrieving method and system, which separately creates and stores a list of files stored in a storage unit of a printer registered in a host, accesses the storage unit when a retrieval command is requested from the host, and transmits the result of the retrieval command to the host.

2. Description of the Related Art

In a system having a host and a plurality of output devices such as printers connected to a network, a user can retrieve a specific file by individually accessing storage units of the printers and outputting a list of files stored therein. In particular, when the user makes a request to the printers to output files stored therein, the printers create lists of files stored in their respective storage units and print the lists on paper. When the user requests access to information of files stored therein, the printers transmit lists of files stored in their respective storage units to the host. Specifically, when the host includes a web controller, the information can be displayed in HTML format.

In conventional systems, although the printers connected to the network have a function to enumerate operations stored for printing, the printers do not have a function to retrieve specific files. Recently, the printers that are connected to the network have a tendency to act as a storage unit on the network that store print data. Accordingly, when the user does not remember a file location, which is stored somewhere among the printers connected to the network, the user must print lists of files with respect to all of the printers on the network and check them. Even though the host includes the web controller, the host must perform this inefficient operation with respect to all of the printers on the network.

### SUMMARY OF THE INVENTION

The present general inventive concept provides a file retrieving method and system, which separately creates and stores a list of files stored in a storage unit of a printer registered in a host, accesses the storage unit when a retrieval request command is received from the host, and transmits the result of the retrieval request to the host.

The present general inventive concept also provides a file retrieving method and system, in which a plurality of printers are registered in one host so that the plurality of printers can be accessed through a single retrieval request.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a method of retrieving specific files stored in a plurality output devices in a system including a host and the plurality of output devices having corresponding storage units connected to a network, the method including: transmitting a retrieval request containing inquiry conditions to one or more output devices registered in the host, and accessing the corresponding storage units of the one or more output devices according to the retrieval request and transmitting the result of the retrieval request to the host. The method may further include displaying the result of the retrieval request and/or outputting a message or warning sound when there is no result of the retrieval request.

The method may further include creating and storing a list of files stored in the corresponding storage units of the one or more output devices, and the list of files may be updated when a new file is stored in the corresponding storage units of the one or more output devices.

File information that corresponds to the inquiry conditions and the result of the retrieval request may include at least one of file names of the files stored in the storage units, dates when the files are saved, names of persons who save the files, IDs of the persons who save the files, and identification information of the output devices having the files stored in their corresponding storage units.

The foregoing and/or other aspects and advantages of the present general inventive concept are also achieved by providing a system to retrieve specific files from a plurality of output devices connected to a network. The system may include: a host connected to the network to access and request a retrieval of file information from storage units corresponding with the plurality of output devices according to inquiry conditions, and the plurality of output devices registered in the host, and the output devices each accessing and retrieving the file information from the corresponding storage unit according to the inquiry conditions and transmitting the result of the retrieval request to the host, and each of the plurality of output devices creates and stores a list of files stored in the corresponding storage unit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a system including a host and output devices connected to a network according to an embodiment of the present general inventive concept;

FIG. 2A illustrates the host of FIG. 1;

FIG. 2B illustrates one of the output devices of FIG. 1;

FIG. 3 is a flowchart illustrating a file retrieving method according to an embodiment of the present general inventive concept; and

FIG. 4 is a view illustrating a retrieved result from a plurality of output devices of the method of FIG. 3.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

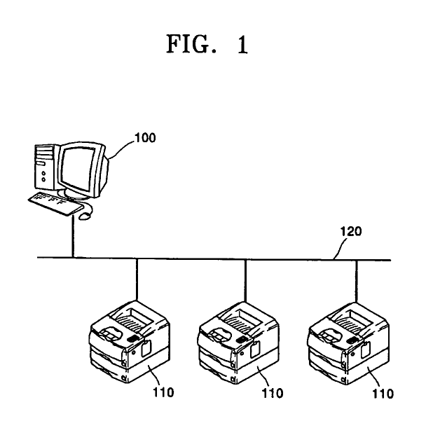

It should be understood that although the present general inventive concept is described below with reference to a plurality of printers as a plurality of output devices in FIGS. 1 through 4, other types of output devices may also be used with the present general inventive concept.

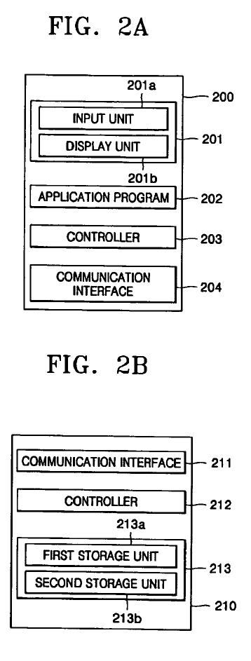

FIG. 1 illustrates a system including a host 100 and a plurality of printers 110 connected to a network 120 according to an embodiment of the present general inventive concept. FIGS. 2A and 2B illustrate a host 200 and a printer 210 according to an embodiment of the present general inventive concept, respectively. It should be understood that the host 100 and the printers 110 of FIG. 1 can be represented by the host 200 and the printer 210 of FIGS. 2B, respectively, and therefore will be referred to interchangeably in the description that follows.

A system according to the present general inventive concept will now be described with reference to FIGS. 1, 2A, and 2B.

Referring to FIG. 2A, the host 200 includes a user interface 201, an application program 202, a controller 203, and a communication interface 204.

The user interface 201 interfaces a user with the host 200 and includes an input unit 201a to input a retrieval request containing inquiry conditions. The inquiry conditions may include file names of files stored in a storage unit, a date when the files were last saved, names of persons who saved the files, IDs of the persons who saved the files, and identification information of a corresponding printer. Other information may also be included in the inquiry conditions. For example, key words can be input as the inquiry conditions to retrieve all files containing the key words in the corresponding file names.

The user interface 201 further includes a display unit 201b to display the result of the retrieval request transmitted from the printers 110 (see FIG. 1). The result of the retrieval request may include the file names, the dates when the files were last saved, the names of the persons who saved the files, the IDs of the persons who saved the files, the identification information of the corresponding printer, file sizes, etc.

A controller 203 may generate a message or warning sound at the user interface 201 to notify the user when the result corresponding to the inquiry conditions is not retrieved. Thus, the user interface 201 may further include a message/warning unit.

The application program 202 manages a registration of the printers connected to the network and communicates with the user interface 201 to input the inquiry conditions to retrieve files from and/or access the printers and/or to display the result of the retrieval request.

The controller 203 receives the retrieval request containing the inquiry conditions from the user interface 201 and transmits the retrieval request to the printers 110 (or 210 of FIG. 2B) through the communication interface 204. Also, in order to display the result of the retrieval request, the controller 203 processes the result of the retrieval request transmitted from the printers 110 (or 210) and transmits the result of the retrieval to the user interface 201. This process will be described below.

If the retrieval request includes a list of the files stored in the printers 110, the controller 203 associates each of the files in the retrieved results with the corresponding printers 110 that store the files. The controller 203 then displays each of the files in the retrieved results with the corresponding printers 110 to the user, as illustrated in FIG. 4. Although not illustrated, if the retrieval request is associated with a specific file “A job,” some file information may be displayed, such as “ASIC_TEAM,” “WST Alpha test,” “A job,” and “2004.4.1,” as illustrated in FIG. 4.

As illustrated in FIG. 2A, the communication interface 204 may include communication hardware, software, or a combination thereof. The communication interface 204 enables the host 200 to transmit the retrieval request to the printers 110 (or 210) and/or receive the result of the retrieval request from the printers 110.

FIG. 2B illustrates the printer 210 according to an embodiment of the present general inventive concept. Referring to FIG. 2B, the printer 210 includes a communication interface 211, a controller 212, and a storage unit 213.

The communication interface 211 may include communication hardware, software, or a combination thereof to communicate with the host 100 (or 200) (see FIGS. 1 and 2A, respectively).

As illustrated in FIG. 2B, the storage unit 213 of the printer 210 may include a first storage unit 213a and a second storage unit 213b. When the retrieval request is transmitted from the host 100 (or 200), the controller 212 accesses the second storage unit 213b to determine if a file corresponding to the inquiry conditions is stored in the first storage unit 213a. The retrieval request includes the inquiry conditions. The inquiry conditions may include file names, a file size, a saved date, etc.

Additionally, the controller 212 outputs the result of the retrieval request to the communication interface 211 to transmit the retrieval request to the host 100 (or 200). If a new file is saved, the list of files, which is stored in the second storage unit 213b, is updated.

The first storage unit 213a stores the actual files listed in the list of files, which may be accessed and printed, and the second storage unit 213b stores the list of the files. The printer 210 may, in response to the retrieval request, print one or more files matching the inquiry conditions if the printer 210 determines that the one or more files are stored in the first storage unit 213a by accessing the second storage unit 213b. The list of files includes the file names of the stored files and/or the saved date of the stored files. After the list of files is created, if a new file is saved in the first storage unit 213a, the list of files is updated by adding a file name and/or a saved date of the new file.

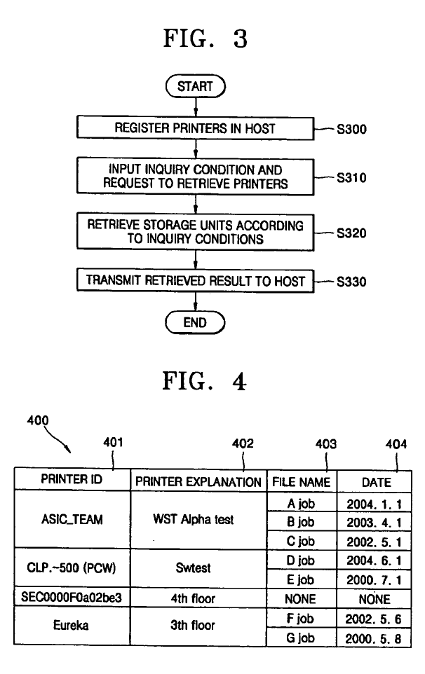

FIG. 3 is a flowchart illustrating a file retrieving method according to an embodiment of the present general inventive concept.

Referring to FIGS. 1-3, in operation S300, printers 110 (hereinafter referred to as printer 210) connected to the network 120 are registered in the host 100 (hereinafter referred to as host 200 of FIG. 2A). The registration may be performed by a known method. For example, after retrieving the printers 210 by a broadcasting method, desired printers are registered.

In operation S310, the user inputs the inquiry conditions through the input unit 201a of the user interface 201 (see FIG. 2A) of the host 200. The inquiry conditions may be associated with the file names or the list of the files stored in the storage units of the printers 210 registered in the host 200.

Although not illustrated, a screen to input the inquiry conditions can be implemented in various embodiments. After inputting the inquiry conditions, the user can press a retrieval request button displayed on the user interface 201.

In operation S320, as illustrated in FIGS. 2A and 2B, the printer 210 registered in the host 200 that receives the retrieval request accesses the corresponding second storage units 213b according to the inquiry conditions. If the user desires to find a specific file, the inquiry conditions may contain at least the file name to query the second storage unit 213b to determine whether the first storage unit 213a includes the specific file. If the specific file is stored in the first storage unit 213a, the controller 212 of the printer 210 retrieves the specific file from the corresponding first storage unit 213a.

If the inquiry condition is a list of the files, the controller 212 retrieves information as to whether or not the list of the files is stored in the second storage unit 213b. As described above, the list of files contains at least names of the files stored in the first storage unit 203a and may also contain file sizes, saved dates, etc. The list of files is updated whenever new files are saved in the first storage unit 213a.

In operation S330, the result of the retrieval request is transmitted to the host 200. As illustrated in FIG. 4, a retrieval request result 400 may include a printer ID 401, a printer explanation 402, a file name 403, and a saved date 404. As is apparent to those skilled in the art, other items (e.g., a file size) can be added to the retrieval request result 400.

FIG. 4 illustrates where the retrieval request result 400 is provided from the printers 210 according to an embodiment of the present general inventive concept, when the retrieval request for the list of the files is transmitted to the printers 210 registered in the host 200 in operation S310.

Referring to FIG. 4, the printers whose printer IDs 401 are “ASIC_TEAM, CLP-500(PCW),” “SEC0000F0a02Be3,” and “Eureka” are registered in the host 200. Also, the printer explanation 402, the file names 403, and the saved date 404 of the files stored in these printers are illustrated in FIG. 4.

According to the present general inventive concept, the retrieval function is additionally provided to a printer, thereby making a contribution to a user convenience when retrieving a specific file from a host connected to a plurality of printers.

Also, since a plurality of printers are registered in a host and all of the registered printers are accessed through a single retrieval command, a need for repetitive operations and/or commands can be prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of retrieving specific files stored in a plurality of output devices in a system including a host and the plurality of output devices having corresponding storage units and being connected to a network, the method comprising:
transmitting a retrieval request containing inquiry conditions to one or more output devices registered in the host; and
accessing the corresponding storage units of the one or more output devices according to the retrieval request and transmitting the result of the retrieval request to the host.

2. The method of claim 1, further comprising:
displaying the result of the retrieval request.

3. The method of one of claim 2, further comprising:
creating and storing a list of files stored in the corresponding storage units of the one or more output devices, and the list of files is updated when a new file is stored in the corresponding storage units of the one or more output devices.

4. The method of claim 2, wherein the accessing of the corresponding storage units of the one or more output devices according to the retrieval request comprises:
querying the corresponding storage units of the plurality of output devices to determine whether the corresponding storage units of the plurality of output devices include one or more files associated with the inquiry conditions; and
transmitting file information about files stored in the corresponding storage units of the plurality of output devices that satisfy the inquiry conditions to the host.

5. The method of claim 4, wherein the displaying of the result of the retrieval request comprises displaying the file information about the files stored in the corresponding storage units of the plurality of output devices that satisfy the inquiry conditions, and the file information includes at least one of:
an output device identifier to identify an output device having a file that satisfies the inquiry conditions stored in the corresponding storage unit,
an output device explanation to identify one of a purpose and a location of the output device having the file that satisfies the inquiry conditions stored in the corresponding storage unit,
a file name to identify the file that satisfies the inquiry conditions that is stored in the corresponding storage unit, and
a save date to identify a date when the file that satisfies the inquiry conditions that is stored in the corresponding storage unit was last saved.

6. The method of claim 4, wherein the displaying of the result of the retrieval request comprises displaying a table having output device information about the one or more output devices and file information about one or more files that satisfy the inquiry conditions and are stored in the corresponding storage units of the one or more output devices.

7. The method of claim 3, wherein file information that corresponds to the inquiry conditions and the result of the retrieval request includes at least one of file names of the files stored in the storage units, dates when the files are saved, names of persons who save the files, IDs of the persons who save the files, and identification information of the output devices having the files stored in their corresponding storage units.

8. The method of claim 1, further comprising:
outputting one of a message and a warning sound when there is no result of the retrieval request.

9. The method of claim 1, wherein the accessing of the corresponding storage units of the one or more output devices comprises accessing the corresponding storage units of the plurality of output devices in response to a single retrieval request transmitted from the host.

10. The method of claim 1, wherein the host comprises a web controller.

11. The method of claim 1, wherein the plurality of output devices comprise a plurality of printers and the corresponding storage units comprise memories associated with each of the plurality of printers.

12. The method of claim 1, further comprising:
storing one or more files in a first storage unit of each of the corresponding storage units of the plurality of output devices; and
storing a list of the one or more files in a second storage unit of each of the corresponding storage units of the plurality of output devices.

13. A method of accessing a plurality of storage units associated with a plurality of output devices connected to a host via a network to retrieve file storage information, the method comprising:
transmitting an inquiry to the plurality of output devices to request file storage information for one or more files stored in the plurality of storage units associated with the plurality of output devices; and
accessing the plurality of storage units associated with the plurality of output devices to retrieve the file storage information for the one or more files.

14. The method of claim 13, further comprising:
receiving the file storage information for the one or more files from the plurality of output devices.

15. The method of claim 14, further comprising:
displaying the file storage information for the one or more files when the one or more files are determined to be stored in the plurality of storage units associated with the plurality of output devices, otherwise outputting a message to notify a user that the file storage information for the one or more files could not be retrieved from the plurality of output devices.

16. The method of claim 13, wherein the inquiry is a single request and is transmitted by the host.

17. The method of claim 13, wherein the inquiry comprises at least one of a file name, a save date, a person who saves the one or more files, a keyword, and an output device identifier.

18. The method of claim 13, wherein the accessing of the plurality of storage units associated with the plurality of output devices comprises:
accessing a plurality of first storage units of each of the plurality of storage units associated with the plurality of output devices to determine, for each of the plurality of storage units, whether the one or more files is stored therein; and
retrieving the one or more files from one or more second storage units of the one or more corresponding storage units determined to include the one or more files.

19. The method of claim 13, further comprising:
maintaining a list of files stored in each of the corresponding storage units of the plurality of output devices, and the list of files for each of the corresponding storage units is accessible by a single retrieval request received from the host.

20. The method of claim 13, further comprising:
registering the plurality of output devices in the host.

21. The method of claim 13, wherein the file storage information includes an output device storage location of the one or more files.

22. A method of obtaining file information from a plurality of printers on a network, the method comprising:
registering the plurality of printers with a host, each of the plurality of printers including a storage unit; and
individually accessing the storage unit of each of the plurality of printers to obtain file print data stored therein in response to a single retrieval request received from the host.

23. The method of claim 22, further comprising:
retrieving the file print data from the storage units of the plurality of printers; and
transmitting the print data to the host.

24. A system to retrieve specific files from a plurality of output devices connected to a network, comprising:
a host connected to the network to access and request transmission of file information from storage units corresponding with the plurality of output devices according to inquiry conditions; and
a plurality of output devices registered in the host, the plurality of output devices each accessing and retrieving the file information from the corresponding storage unit according to the inquiry conditions and transmitting the result of the retrieval to the host, and each of the plurality of output devices creates and stores a list of files stored in the corresponding storage unit.

25. The system of claim 24, wherein the host displays the result of the transmission request or outputs a message or warning sound when there is no result of the transmission request.

26. The system of claim 24, wherein each of the file information that corresponds to the inquiry conditions and the result of the transmission request includes at least one of file names of the files stored in the storage units, dates when the files are stored, names of persons who save the files, IDs of the persons who save the files, and identification information of the output devices having the files stored in corresponding storage units.
